(19) United States
(12) Patent Application Publication
(10) Pub. No.: US 2026/0014885 A1
(43) Pub. Date: Jan. 15, 2026

(54) DETERMINING FEATURE POSES OF ELECTRIC VEHICLES TO AUTOMATICALLY CHARGE ELECTRIC VEHICLES

(71) Applicant: EMBOTECH AG, Zürich (CH)

(72) Inventors: David André MAUDERLI, Zürich (CH); Thivaharan ALBIN RAJASINGHAM, Zürich (CH)

(73) Assignee: EMBOTECH AG, Zürich (CH)

(21) Appl. No.: 18/994,761

(22) PCT Filed: Jul. 15, 2022
(86) PCT No.: PCT/EP2022/069847

§ 371 Date: Jan. 15, 2025

(51) Int. Cl. B60L 53/37; B25J 9/16; B25J 11/00; B25J 19/02

(52) U.S. Cl. CPC B60L 53/37; B25J 9/1697; B25J 11/00; B25J 19/023

(57) ABSTRACT

The invention is notably directed to a computer-implemented method for automatically charging an electric vehicle via an end effector (10) of a robotic arm (40) of an automated vehicle charging robot. The end effector is assumed to be structured so as to be able to connect to a charge port (220) of a vehicle. In addition, the automated vehicle charging robot further includes a camera system (102) having depth sensing capability. The method comprises the following steps. First, a reference position of a reference feature (210) of the vehicle is estimated thanks to the camera system. Next, a pose of the charge port of the vehicle is determined based on the estimated reference position. The robotic arm is subsequently instructed to actuate the end effector, based on the determined pose of the charge port, to connect the end effector to the charge port with a view to charging the vehicle. The reference position is estimated as follows. Both a 2D image and a depth image of a surface portion of the vehicle are obtained. This surface portion includes the reference feature, i.e., the feature of interest. Contour points of the reference feature are then extracted from the 2D image obtained. The 3D coordinates of the extracted contour points are subsequently reconstructed based on the depth image obtained. A geometric object (such a 2D plane) is then matched to the reconstructed 3D coordinates, e.g., by fitting the geometric object to the reconstructed 3D coordinates. Eventually, the reference position of the reference feature is determined based on the matched geometric object. The invention is further directed to related automated vehicle charging robots and computer program products.

### BACKGROUND

The invention relates in general to the field of automated vehicle charging robots, methods for automatically charging electric vehicles, and computer program products for automatically charging electric vehicles, via an end effector of a robotic arm. In particular, it is directed to methods estimating the position of a reference feature (or the pose of a corresponding coordinate system) by extracting contours of this feature (based on a 2D image) and deprojecting the contours into 3D space using depth information contained in an associated depth image.

An electric vehicle (EV) is a vehicle that relies on one or more electric motors for propulsion. Of particular interest are road vehicles (i.e., electric cars) that can be powered autonomously by a battery. Such EVs are mostly designed as plug-in electric vehicles (PEVs, including all-electric vehicles and plug-in hybrid vehicles), i.e., road vehicles that utilize an external source of electricity (e.g., a charging station or wall socket connecting to the power grid) to charge and store electrical power in their rechargeable battery packs.

Given the sparsity of charging stations for EVs, automated vehicle charging (AVC) is becoming increasingly attractive as such systems increase the charging throughput per station. Existing AVC prototypes typically rely on vision-based plug pose estimates. Examples of such prototypes are described in “Autonomous Charging of Electric Vehicles in Industrial Environment”. Hirz, M., Walzel, B., & Brunner, H. (2021). Tehnički Glasnik, 15 (2), 220-225. https://doi.org/10.31803/tg-20210428191147.

Designing a fully automated vehicle charging system is not an easy task, notably because the vehicle body often lacks distinctive features, which makes it difficult to estimate the position (let alone the pose) of features of the vehicle (like a charge port door) using conventional computer vision techniques.

### SUMMARY

According to a first aspect, the present invention is embodied as a computer-implemented method for automatically charging an electric vehicle via an end effector of a robotic arm of an automated vehicle charging robot. The end effector is assumed to be structured so as to be able to connect to a charge port of a vehicle. In addition, the automated vehicle charging robot includes a camera system having depth sensing capability. The method comprises the following steps. First, a reference position of a reference feature of the vehicle is estimated thanks to the camera system. Next, a pose of a charge port of the vehicle is determined based on the estimated reference position. The robotic arm is subsequently instructed to actuate the end effector, based on the determined pose of the charge port, to connect it to the charge port with a view to charging the vehicle.

The reference position is estimated as follows. Both a 2D image and a depth image of a surface portion of the vehicle are obtained. This surface portion includes the reference feature, i.e., the feature of interest. Contour points of the reference feature are then extracted from the 2D image obtained. The 3D coordinates of the extracted contour points are subsequently reconstructed based on the depth image obtained. A geometric object (such as a 2D plane) is then matched to the reconstructed 3D coordinates, e.g., by fitting the geometric object to the reconstructed 3D coordinates. Use can advantageously be made of a random sample consensus algorithm, to ensure robustness against outliers. Eventually, the reference position of the reference feature is determined based on the matched geometric object.

That is, the position of the reference feature is estimated by extracting its contours (based on a regular 2D image) and then deprojecting the contours into 3D space by means of depth information contained in the depth image. So, instead of using, e.g., a conventional 3D point set registration algorithm, the present inventors propose to exploit a combination of 2D image and depth information, which makes it possible to compensate for the lack of distinctive geometric features of the car body and adequately locate the target feature. The proposed approach outperforms conventional vision-based methods; it is notably well suited to determine the pose of a charge port door, despite the lack of distinctive geometric features (besides the contour of the charge port door) in the corresponding 2D image. The robustness of the proposed approach makes it suitable for applications to automated vehicle charging robots.

Preferably, the reference position of the reference feature is determined by computing a centroid of the reconstructed 3D coordinates and projecting the computed centroid onto the geometric object as matched to the reconstructed 3D coordinates. This makes it possible to locate the position of the reference feature fairly accurately along the depth direction, something that is very difficult with conventional vision-based methods. In embodiments, the method further comprises estimating, thanks to the camera system, the pose of a reference coordinate system (i.e., a reference frame) of the reference feature based on the matched geometric object. Note, the “pose” is defined as including both the position and orientation. Thus, both the position and the orientation of the reference feature are estimated. The pose of the charge port can then be determined based on the pose of the estimated reference coordinate system, i.e., using the reference coordinate system as an initial estimate or reference. In particular, the orientation of the reference feature can be exploited to adequately determine the pose of the charge port (e.g., using a visual odometry-like algorithm).

That is, the pose of the charge port is preferably determined by first obtaining a rough estimate of the pose and then refining this rough estimate based on a geometric transformation determined by comparing a query image of the charge port, as obtained thanks to the camera system, with a representation of the charge port corresponding to a reference configuration, for which the pose of the end effector (and also the camera lens) with respect to the charge port is known. Once this this transformation is obtained, it is possible to compute the final transformation required to optimally align the end effector with the charge port, with a view to connecting the plug, given that all the other transformations required for this are already known, e.g., from calibration. The approach can be compared to a visual odometry technique; it provides more reliable orientations than conventional methods. Note, the initial estimate may be determined by using a similar algorithm as used to determine the pose of the charge port door.

The reference feature may notably be a door of the charge port. In that case, the method may further comprise instructing the robotic arm to actuate the end effector to open the door, based on the estimated pose of the reference coordinate system; this is done prior to determining the pose of the charge port. In other words, the charge port door is used as a useful intermediate, not only to obtain an initial estimate of the position of the charge port but also to automatically open the door, e.g., thanks to the same end effector that is later used to charge the vehicle. To that aim, the end effector may advantageously be equipped with a specific actuator, which, e.g., protrudes from a body of an electrical connector of the end effector, transversely to an extension direction of this body.

The contour points of the reference feature can be extracted by determining a closed contour in the 2D image and then extracting the contour points from this closed contour. Preferably, said closed contour is determined by first identifying all closed contours in the 2D image and then determining said closed contour as one of the closed contours that has a largest area.

The determination of this closed contour may for instance comprises comparing a candidate contour to a reference contour. This institutes a validation step, which, in turn, makes it possible to reject false positives.

In preferred embodiments, extracting the contour points of the reference feature further comprises segmenting the 2D image by applying a thresholding method to obtain a segmented image. Preferably, the 2D image is segmented by running an adaptive binary threshold algorithm, the latter more preferably causing to compute a per-pixel threshold by convolving the 2D image with a Gaussian kernel. As the threshold value differs from pixel to pixel, an adaptive binary threshold algorithm makes it possible to adequately detect regions that are locally much darker than their surroundings.

The determination of the closed contour may possibly involve a morphological closing operation that is applied to the segmented image to obtain an augmented image, whereby the closed contours are identified from the augmented image. This way, missing contour parts can be inferred and inserted in the image, to avoid an inadvertent invalidation of the resulting contour

In embodiments, extracting the contour points further comprises filtering the 2D image using a low-pass filter to obtain a filtered image, prior to segmenting the filtered image. The filter averages out rapid changes in intensity, which results in blurring or smoothing the image. This makes it possible to reduce the noise and eventually allows smoother contours to be extracted. In preferred embodiments, the depth image is obtained by instructing the camera system to: obtain two image datasets from two sensors of the camera system that are spaced apart from each other; and forward the two datasets to a processor, for it to compute depth values by correlating pixel values in the two image datasets to generate a depth image. The method may also align the 2D image and the depth image obtained, prior to extracting the contour points, if necessary. The depth image may advantageously be obtained by instructing the camera system to illuminate the surface portion with a pattern of infrared light, so as to impact the pixel values of the two image datasets obtained. This improves the depth accuracy of features having low texture, as is the case with car bodies.

According to another aspect, the invention is embodied as an automated vehicle charging robot. The latter comprises a functionalized robotic arm, a camera system, and a computerized system. The functionalized robotic arm includes a robotic arm and an end effector. The end effector is connected to the robotic arm and accordingly functionalizes the arm. The end effector may also be supplied separately. Still, the end effector is designed to be connectable to the robotic arm, e.g., axially. The end effector is further structured to connect to a charge port of a vehicle. The camera system is assumed to have depth sensing capability. The computerized system is operatively connected to the functionalized robotic arm and is configured to perform all steps of any of the methods described above.

In embodiments, the end effector includes a connecting module, an electrical connector, and an actuator. The connecting module is delimited by a reference plane and is designed to enable a connection of the end effector to the robotic arm on a first side of the reference plane. The electrical connector includes a body and a plug, where the plug is designed to connect to the charge port and arranged at an end of the body. The body extends from the connecting module to the plug on a second side of the reference plane (the second side is opposite to said first side), along an extension direction that is transverse to the reference plane. The actuator protrudes from the body, transversely to the extension direction. The actuator is generally designed to actuate a door of the vehicle charge port.

Thus, the end effector can be rotated by the robotic arm, so that the actuator can be set in position to safely actuate a charge port door of an electric vehicle, by pressing the door at a certain location. Accordingly, there is no need to provide a separate tool (another end effector or robot) to open the vehicle charge port door. Thus, this makes it possible to reduce the time duration of the overall plugging process, as well as the costs, given that a single tool is needed to both open the charge port door and plug the connector.

In preferred embodiments, the extension direction of the body is inclined with respect to an axial direction that is perpendicular to the reference plane, whereby the extension direction of the body forms an angle with the axial direction, wherein this angle is preferably between 25 degrees and 45 degrees, and more preferably between 30 degrees and 40 degrees. The inclination of the extension direction ensures, together with the transverse actuator, a collision safety margin that keeps all elements on the backside of the tool away from the car body.

Accordingly, this allows the end effector (and thus the actuator) to be suitably rotated to open the charge port door without causing collisions. Still, other types of end effectors may be contemplated.

Preferably, the connecting module includes several submodules designed to cooperate with each other to enable said connection to the robotic arm, preferably as a controllably detachable connection. E.g., the submodules may include two magnetic parts forming an electropermanent magnet, which enables the controllably detachable connection. This way, a same robotic arm can successively pick up and plug several end effectors into respective charge ports. Alternatively, or in addition, the robotic arm can choose among different end effector plug formats, corresponding to distinct charge port standards.

In addition, the camera system may include a camera that is fixed to one of the submodules that is the farthest from the plug, to enlarge the field of view of the camera.

In embodiments, the submodules include a force-torque sensor, which is axially connected or connectable to another one of the submodules, and the camera is fixed to the force-torque sensor.

Preferably, the camera is arranged on one side of a plane containing the extension direction and a projection of the latter in the reference plane, in such a manner that neither the actuator nor the body of the electrical connector is in a field of view of the camera.

In preferred embodiments, the camera is a stereo vision camera that includes two sensors having respective lenses. The two sensors are arranged along a vertical axis, i.e., an axis that is parallel to a rotation axis of the camera. That is, the camera is vertically arranged and is further tilted with respect to this rotation axis, without substantially sticking out from the force-torque sensor. This makes it possible to avoid undesired inertial effects and lower the risk for the camera to accidentally interfere with the force-torque measurements, due to potential inadvertent tension of the cable of the camera. The optical axes of the lenses are parallel to each other and are furthermore, each, transverse to the reference plane. The optical axes are rotated around a rotation axis that is parallel to the projection of the extension direction in the reference plane, by an offset angle chosen so that neither the actuator nor the body of the electrical connector is in the field of view of the camera. The offset angle is preferably between 10 degrees and 30 degrees, and more preferably between 17 degrees and 23 degrees.

According to a final aspect, the invention is embodied as a computer program product for automatically charging an electric vehicle via an end effector of a robotic arm of an automated vehicle charging robot. The end effector is again assumed to be structured so as to be able to connect to a charge port of a vehicle. The robot further includes processing means and a camera system having depth sensing capability. The computer program product comprises a computer-readable storage medium having computer-readable program code embodied therewith. The computer-readable program code can be evoked by said processing means to cause the latter to estimate a reference position of a reference feature of the vehicle by: obtaining both a 2D image and a depth image of the relevant surface portion of the vehicle (i.e., including the reference feature); extracting contour points of the reference feature from the 2D image obtained; reconstructing, based on the depth image obtained, 3D coordinates of the extracted contour points; matching a geometric object to the reconstructed 3D coordinates; and determining the reference position of the reference feature based on the matched geometric object.

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIG. 1 is a 3D view of an automated vehicle charging robot, which includes a robotic arm and an end effector with an electrical connector, according to embodiments. The end effector is designed to plug into and enable the charge an electric vehicle;

FIG. 2 is a 3D view of an end effector, in which an actuator protrudes from the body of the electrical connector, according to embodiments. The actuator is designed to actuate a door of a vehicle charge port. The end effector further includes a connecting module, which allows the end effector to be connected to the robotic arm on its back side;

FIG. 3 is an exploded view of the end effector of FIG. 2, showing relationship and order of assembly of submodules of the connecting module of the end effector. Intermediate submodules form an electropermanent magnet, as in embodiments;

FIGS. 4A, 4B, and 4C, are views illustrating how an end effector can be actuated (i.e., rotated and moved), via the robotic arm, to first open the charge port door of a vehicle (FIG. 4A, top view), and then plug the electrical connector of the end effector into the charge port of the vehicle (FIG. 4B, side view; FIG. 4C, top view) to charge the vehicle, as in embodiments; FIG. 5 is a flowchart illustrating high-level steps of a method of operating a functionalized robotic arm to open a charge port door of an electric vehicle, and then plug an end effector into the charge port to charge the vehicle, according to embodiments.

FIG. 6 is another flowchart, which illustrates method steps that are performed to estimate the pose of a coordinate system of a charge port door of the vehicle, in embodiments.

FIG. 7 schematically represents the high-level architecture of an automated vehicle charging system, which includes a functionalized robotic arm and a computerized system, as in embodiments; and

FIGS. 8A-8H illustrate the results obtained by performing successive steps of the method of FIG. 6. Starting from a 2D image of a charge port door of a vehicle (FIG. 8A), a 2D plane is matched to the charge port door, FIG. 8H, to determine a pose of the charge port door, as in embodiments.

The accompanying drawings show simplified representations of devices or parts thereof, as involved in embodiments. Technical features depicted in the drawings are not necessarily to scale. Similar or functionally similar elements in the figures have been allocated the same numeral references, unless otherwise indicated.

Methods, automated vehicle charging robots (as well as devices involved therein), and computer program products, embodying the present invention will now be described, by way of non-limiting examples.

### DETAILED DESCRIPTION OF EMBODIMENTS OF THE INVENTION

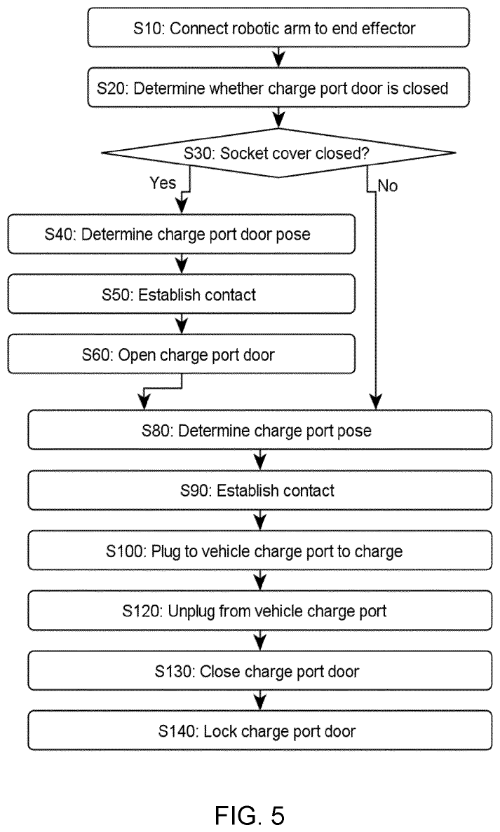

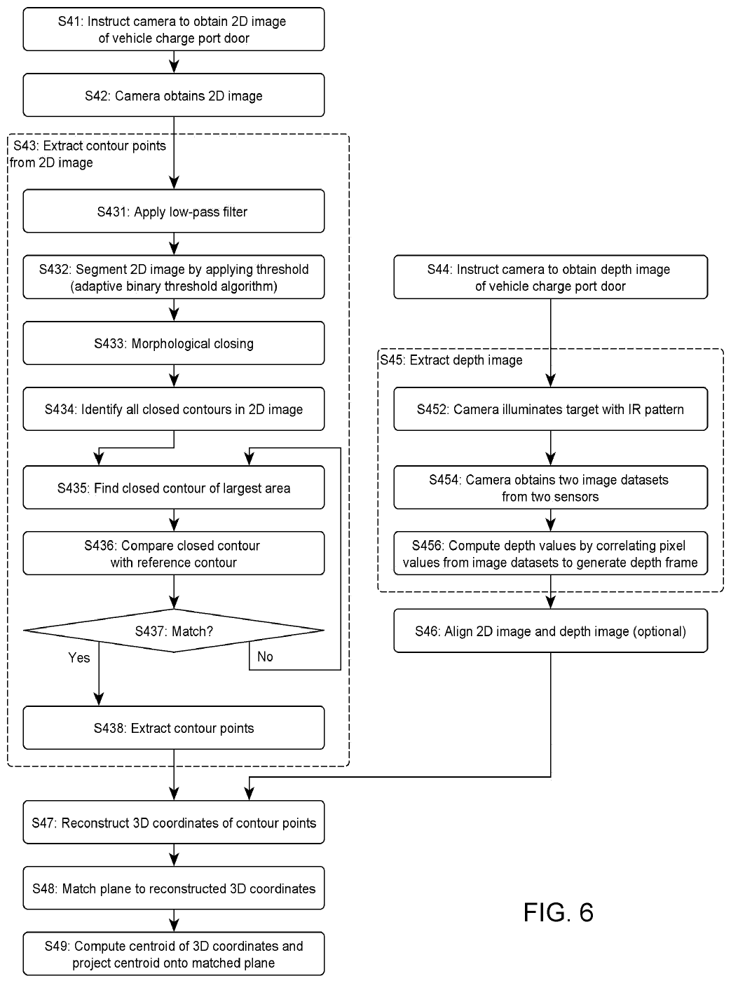

The following description is structured as follows. General embodiments and high-level variants are described in section 1. Section 2 addresses particularly preferred embodiments. Section 3 concerns technical implementation details. Note, the present method and its variants are collectively referred to as the “present methods”. All references Sn refer to methods steps of the flowcharts of FIGS. 5 and 6, while numeral references and capital letters pertain to devices, components, and concepts, involved in embodiments of the present invention.

### 1. General Embodiments and High-Level Variants

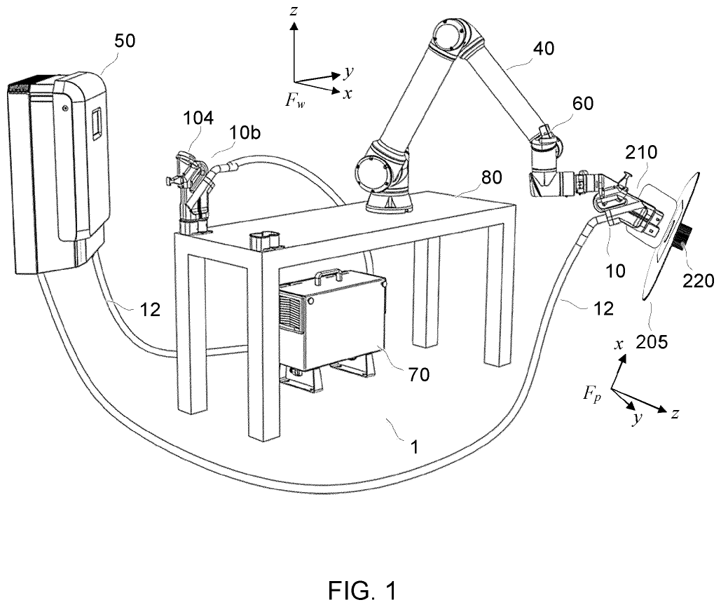

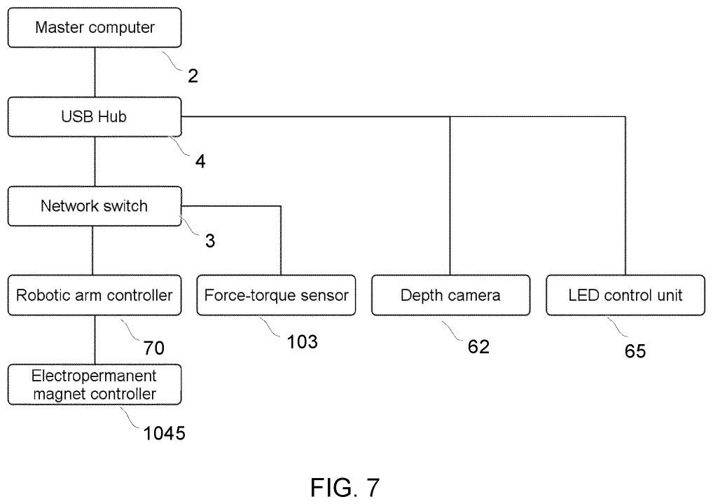

A first aspect of the invention is now described in detail in reference to FIGS. 1-8H. This aspect concerns a method for automatically charging an electric vehicle via an end effector 10 of a robotic arm 40 of an automated vehicle charging robot 1 such as depicted in FIG. 1. The end effector is assumed to be structured so as to be able connect to a charge port 220 of a vehicle. In addition to the robotic arm and the end effector, the automated vehicle charging robot 1 further includes a camera system, which has depth sensing capability. The camera system may for instance include a camera 102 that is fixed to the end effector 10. Examples of suitable end effector designs are described later in detail, notably in section 2.3. The method is primarily performed by a computerized system, such as a master computer 2 (see FIG. 7), which is operatively connected to the robotic arm 40 to enable steps as described below.

The high-level steps of the method are the following. Reference is made to the flow of FIG. 5. First, the method estimates (step S40) a reference position of a reference feature 210 (e.g., a charge port door) of the vehicle. This is achieved thanks to the camera system 102. Second, the method determines (step S80) a pose of a charge port 220 of the vehicle, based on the estimated reference position of the reference feature. Finally, having determined the pose of the charge port, the method accordingly instructs (steps S90, S100) the robotic arm 40 to actuate the end effector 10 to connect S100 it to the charge port 220. The aim is to electrically charge the vehicle.

It is necessary to reliably estimate S40 the reference position of the reference feature, given that the subsequent determination S80 of the charge port pose depends on step S40, be it indirectly. This is not an easy task, because images of the reference feature may lack distinctive geometric features, such that conventional vision-based methods may fail. Still, a remarkably simple (yet efficient) solution that the present inventors came up with is the following.

This solution relies on both a 2D image and a depth image of a relevant surface portion of the vehicle, i.e., the surface portion that includes the feature of interest. Such images are obtained at steps S41 and S44, respectively (see the flow of FIG. 6). Next, contour points of the reference feature 210 are extracted (step S43) from the 2D image obtained. The 3D coordinates of the extracted contour points can subsequently be reconstructed S47, using information contained in the depth image, because the depth values can be mapped onto corresponding pixel values of the 2D image. A given geometric object is subsequently matched S48 to the reconstructed 3D coordinates, e.g., by fitting this object to the reconstructed 3D coordinates. Eventually, the reference position of the reference feature 210 is simply determining S49 based on the matched geometric object.

Beyond the position of the reference feature 210 of the vehicle, the method may actually determine the actual pose of this feature e.g., as a coordinate system corresponding to that feature. Note, the “pose” is here defined to include both the position and orientation of a feature of interest; the position of the reference feature is determined as part of determining its pose. Thus, the methods described herein may be based on the pose of the reference feature, rather than its sole position, as in embodiments discussed later in detail.

The position (or pose) of the reference feature 210 is estimated S40 with a view to later determining S80 the pose of the charge port 220 of the vehicle. Still, the reference feature 210 may only be indirectly related to the charge port 220 of the vehicle, provided that the reference feature and the charge port are related by way of a fixed geometrical transformation. That is the reference feature is mechanically constrained with respect to the charge port. For example, the reference feature may be a charge port door 210 or a charge port frame (i.e., the physical frame surrounding the charge port). Although the charge port door is rotatable with respect to its rotation axis, this axis is mechanically fixed with respect to the charge port. Estimating the position or pose of this reference feature helps the robot 1 open the charge port door. Having done so, the robot 1 is then able to determine the pose of the charge port 220 more easily as it can start from the position (as now known) of the charge port door 210. In turn, the robot 1 is able to connect (i.e., plug) an electrical connector 106, 108 of the end effector into the charge port 220, with a view to charging the vehicle. In the above example, the charge port door acts as a useful intermediate, not only to obtain an initial estimate of the position of the charge port but also to automatically open the door, e.g., thanks to the same end effector that is later used to charge the vehicle. In variants, the method may rely on other types of intermediate features, such as windows (e.g., side door windows, quarter glass, etc.) or tyres, if not the car body itself. According to the proposed approach, the position of the reference feature (or the entire pose of the corresponding coordinate system) is estimated by extracting contours of this feature based on a regular 2D image (which can be a colour or a grayscale picture) and then properly deprojecting the contours into the 3D space by means of the depth information contained in the depth image. In the present context, an image (whether a 2D image of a depth image) means a dataset that can be used to display or process information. A geometric object (e.g., a 2D object such as a plane) is eventually matched to the 3D coordinates of the contour points, which allows the feature position (or pose) to be inferred from the matched object, possibly in combination with assumptions about the feature pose obtained. The geometric object can be matched to the 3D coordinates by merely fitting this object to the coordinates. Use is advantageously made of the random sample consensus (RANSAC) algorithm, to ensure robustness against outliers. However, other optimization methods (e.g., based on minimization procedures) can be contemplated too.

The geometric object can for instance be a plane or a spherical cap. More generally, it can be a parametric surface, an algebraic surface, or a polyhedral surface, for example. Any reference point of the matched object can then be selected as the reference position (e.g., the apex of the spherical cap). Similarly, the coordinate system of the matched object can be selected as the reference frame (e.g., a coordinate system whose origin is fixed to the apex of the spherical cap and axes are tangential to the surface). A computationally simpler approach, however, is to fit a 2D plane and then project the 3D contour point centroid onto that plane.

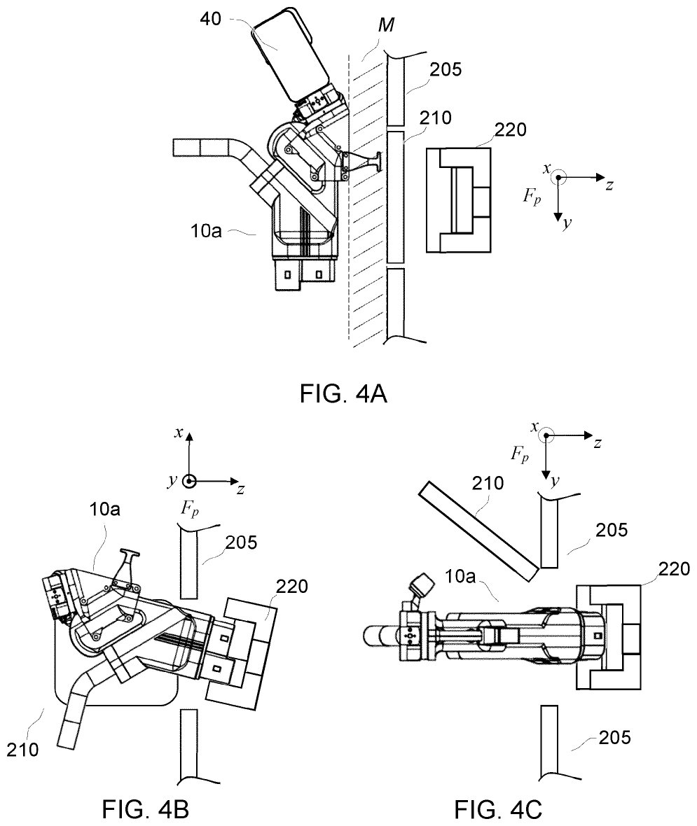

Note, several coordinate systems (also referred to as frames, typically Cartesian coordinate systems) are used in the accompanying drawings. The frame Fₚ (see FIGS. 1, 4A-4C) refers to the coordinate system of the charge port 220; the z-axis is parallel to the normal to the plane of the car body and points away from the effector as the latter is positioned to plug into the charge port, see FIG. 1. The world coordinate system is denoted by F_{w}; its z-axis points upward, see FIG. 1. The frame F_{c} refers to the natural coordinate system of the connecting module 100, described later in reference to FIGS. 1-3. The plane (y, z) of the connecting module frame F_{c} is parallel to the reference plane P, while the x-axis of the connecting module frame F_{c} is parallel to the axial direction of the connecting module, along which the end effector preferably connects to the robotic arm 40. The direction Dₑ extends in the plane (x, z) of the connecting module frame F_{c} and forms an angle α with the axis x of Fc (for reasons explained later), while the direction D_{c} is parallel to this axis x. The direction Dₐ extends in (x, z) and forms an angle equal to α+90° with respect to the axis x of F_{c}. Finally, each of the additional directions Dₚ and Dₜ shown in the drawings are parallel to the axis z of F_{c}.

The proposed approach is well suited to determine the pose of a charge port door 210, as mostly assumed in the following. When the door 210 is closed, the car body geometry in the vicinity of the charge port door is almost planar. This means that there are no distinctive features to estimate in-plane translations and rotations by methods purely based on geometric information such as 3D point set registration algorithms. Thus, the present inventors have concluded that methods that are solely based on point clouds are not suitable in such situations. That is, the accuracy of the point set registration algorithms is too low if the plug door is closed. A similar conclusion holds with other reference features, such as side door windows. So, instead of using a conventional 3D point set registration algorithm, the present inventors propose to exploit a combination of 2D image and depth information to compensate for the lack of distinctive geometric features and locate the target feature in the query images.

For example, the present methods may project the centroid of all contour points onto the matched plane to obtain the position of the origin of the reference frame. That is, the reference position can be determined S49 by computing the centroid of the reconstructed 3D coordinates and projecting the computed centroid onto the plane as matched to the reconstructed 3D coordinates. The normal vector of the plane and the projected centroid (i.e., a reference point) completely defines the pose of the plane.

Still, additional constraints or information can be used to position and orientate a 3D coordinate system (typically a Cartesian coordinate system). In that case, three orthogonal vectors need be positioned and oriented, instead of a single vector (the normal vector of the plane). I.e., the normal vector of the plane can possibly be used in combination with assumptions about the car orientation to determine the orientation of a 3D reference frame, if necessary. For example, assume that the reference feature is a charge port door, then the following two conditions can be applied, which makes it possible to determine a unique 3D orientation of the door: (i) The z-axis of the door coordinate system Fₚ is parallel to the plane normal and points away from the camera 102, while (ii) the y-axis of the door coordinate system is perpendicular to the z-axis of the world coordinate system F_{w}, see FIG. 1. Using a conventional orientation, the x and y axes of the world frame span a horizontal plane, while the z-axis points upward (to the sky).

To obtain the origin of the cover door coordinate system, the centroid of all 3D door contour points is projected onto the matched plane.

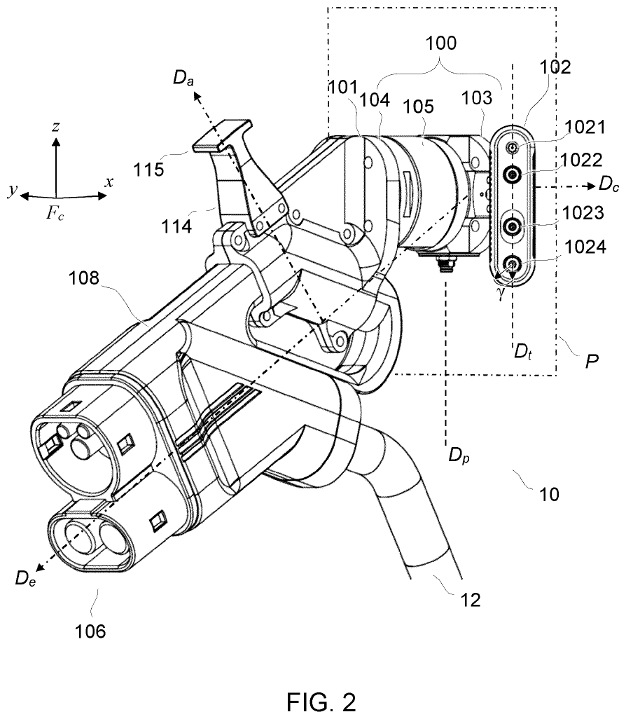

Use is made of a camera system 102 having depth sensing capability. Depth cameras are known per se. The camera 102 can for instance be a stereo depth camera, i.e., having two sensors 1022, 1024 (see FIG. 2), spaced a small distance apart, which are used to obtain distinct (albeit close) images. Since the distance between the sensors is known, comparing the two images allows depth information to be extracted. That is, the difference in the perspectives is used to generate a depth map by calculating a numeric value for the distance from the imagers to every point in the scene.

The camera 102 may further include an infrared (IR) projector 1023. The IR projector illuminates the scene with IR light to collect depth data. I.e., the stereo vision implementation relies on two imagers 1022, 1024, and the IR projector. The IR projects a non-visible, static IR pattern (typically a set of random points), which is used to improve depth accuracy in scenes with low texture, as is the case with car bodies. The two imagers 1022, 1024 capture the scene and forward imager data to the depth imaging vision processor, which calculates depth values for each pixel in the image by correlating points on the two images, by exploiting the shift between corresponding IR points on the two images. The depth values form a depth image. The depth values are then typically aggregated with the pixel values to generate a single image with embedded depth information. I.e., the image combines pixel and depth values. In the present context, however, two distinct datasets are needed, one corresponding to the pixel values (as in usual 2D images), the other capturing the corresponding depth information. An example of a detailed pipeline is discussed in detail in section 2.2.

As explained above, the present methods may estimate S40 the pose of a reference frame of the reference feature 210, based on the matched geometric object, beyond the sole reference position. That is, the reference position of the reference feature 210 is estimated S40 as part of estimating the pose of the reference frame. This means that the pose of the charge port 220 can eventually be determined based on the pose of the estimated reference frame. As said, the pose includes both the position and orientation of a feature in the 3D space. So, not only the algorithm estimates a reference position, but also a reference orientation. Estimating the orientation of the reference feature proves very useful where a visual odometry-like algorithm is additionally used, as the latter can advantageously start from the known orientation of the vehicle.

More precisely, the present methods may estimate the 3D pose of a coordinate system that is associated with the reference feature. This can be achieved by fitting a geometric model to the contour points, where the geometric model has a coordinate system attached to it. So, the matching procedure fully determines the transformed pose of the coordinate system attached to the geometric model.

Note, when attempting to fit a 2D plane, the pose of the corresponding 3D coordinate system cannot be fully estimated in terms of plane rotations and translations, because fitting a 2D plane only results in determining the origin position and orientation of the corresponding normal vector. Still, a full 3D coordinate system can be determined by imposing further constraints to set the two additional unit vectors in the plane. As discussed above, a convenient approach is to set one of these two unit vectors perpendicular to the z-axis of the F_{w} frame, which determines the second in-plane vector. A similar issue arises where a spherical cap is used instead of a 2D plane. In that case too, it is possible to exploit assumptions about the pose of the car, in addition to fitting the geometric model.

Once the pose of the charge port door has been estimated, the method may instruct S50, S60 the end effector 10 to open the door 210. The pose of the reference frame can for instance be exploited to actuate (i.e., rotate and translate) the end effector, for it to press a given area of the door, which results in opening the latter, as depicted in FIG. 4A. To that aim, the end effector advantageously includes an actuator that protrudes transversely from the body 108 of the electrical connector 106, 108. This way, the end effector can be suitably rotated by the robotic arm 40, so that the actuator 114, 115 can be set in position to safely actuate a charge port door 210, by pressing the door 210 at a certain location, as depicted in FIG. 4A.

Next, once the door is opened, the pose of the charge port 220 can be accurately determined. Note, a similar deprojection technique can be used at this point, to determine the pose of the charge port 220. Preferably, however, a distinct (or additional) algorithm is used. This algorithm may advantageously be a visual odometry algorithm, as discussed below. More generally, various vision algorithms are known, which may be used in the present context. In all cases, use can be made of the camera 102, to take new images of the charge port and determine its position and orientation.

A preferred approach to determine the pose of the charge port 220 is the following; it relies on a two-step procedure. First, a rough estimate of the pose is obtained S80, using a conventional estimator (e.g., based on computer-vision) or a method similar to the method described above, i.e., for determining the pose of the reference feature. This rough estimate is then refined based on a geometric transformation, which is determined by comparing a query image of the charge port with a reference representation of the charge port. In detail, the query image is obtained thanks to the camera system. The reference representation of the charge port corresponds to a reference configuration, for which the pose of the end effector (and thus the camera lens) with respect to the charge port is known. Once this this transformation is obtained, it is possible to compute the final transformation required to optimally align the end effector with the charge port, with a view to connecting the plug to the charge port, given that all the other transformations (i.e., between, on the one hand, the camera and the reference configuration and, on the other hand, between the camera and the plug) required for this are already known, e.g., from calibration. Eventually, the final transformation obtained makes it possible to move the end effector from the current pose (corresponding to the query image) to an optimal pose, in which the plug is optimally aligned with the charge port.

The second step can be compared to a visual odometry algorithm. A reason for doing so is that the accuracy achieved by conventional estimators may be insufficient. Note, the charge port pose as obtained by conventional estimators may well be accurate enough to plug the connector, especially when further exploiting a force feedback, as in embodiments. However, the translational estimation error will likely be on the order of 1 cm, which is often insufficient to suitably align the plug 106 of the connector 106, 108 with the charge port. Thus, as the present inventors concluded, a relatively simple workaround is to involve a two-step method as discussed above, to refine the initial position estimate, assuming the plug orientation is already known.

Such a two-step approach is more robust than conventional charge port pose estimation methods, which mostly attempt to directly infer an orientation from visual charge port features. Now, one problem with such methods is that small errors in the feature detection can lead to substantial orientation estimation errors (e.g., because the pins are very close to each other). Instead, the two-step approach as proposed above is more robust, given that the query image will also include visual features of the surrounding car body (such features are further apart, resulting in less error propagation).

In detail, the second step can be performed as follows. step actually decomposes into the three following substeps:
(i) First, the camera is moved at a mid-range distance (e.g., of 20 cm-40 cm) from the initial charge port pose estimate, so as to centre the charge port in an image taken by the camera (typically an RGB image). The RGB image plane will be essentially parallel to the estimated charge port plane since the accuracy of the initial orientation estimate is assumed to be already quite accurate.
(ii) Second, using the query image and a known representation thereof, the algorithm determines the rigid-body transformation between the current camera pose and the camera pose corresponding to the known representation of the charge port. Because the charge port orientation is already known with sufficient accuracy, this transformation can advantageously be limited to a small number (e.g., 4) of degrees of freedom. Doing so eventually improves the estimation accuracy: taking less parameters into consideration reduces the search space of the algorithm and thus results in improving the accuracy.
(iii) Finally, the current charge port pose can be calculated, e.g., in the base coordinates of the robot 1.

The first and third substeps are standard steps in visual odometry techniques. The second substep can advantageously make use of the following pipeline.
a. Feature detection. The algorithm finds key points of interest in the RGB image of the charge port (although a grayscale image may be used as well).
b. Feature matching. For every key point in the query RGB image, the algorithm finds its corresponding key point in the known reference geometry of the charge port. This can be done by comparing the relative positions of the key points to each other.
c. Motion estimation. Given the 2D-to-2D correspondences identified, the algorithm computes the camera position. Usually, the camera motion between query image and the known representation thereof can only be computed up to a scale factor when based on such 2D-to-2D correspondences. However, because the charge port dimensions are normally known, a suitable scale factor can easily be retrieved.

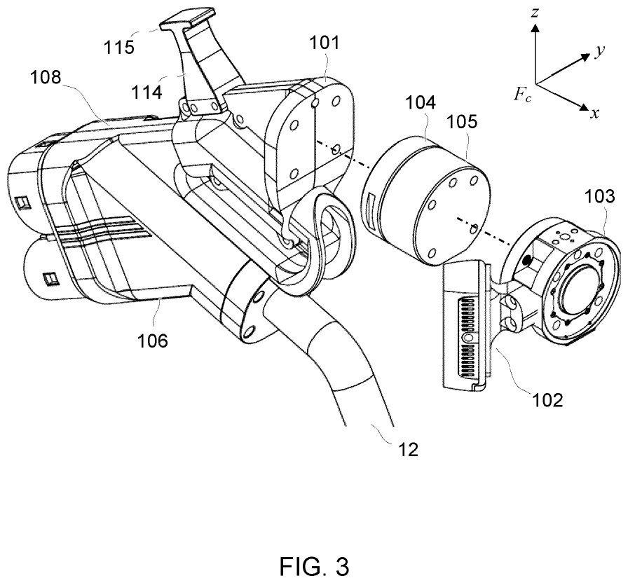

Referring back to FIGS. 1-3, another aspect of the invention is now discussed in detail, which concerns an automated vehicle charging robot 1, such as illustrated in FIG. 1. The robot 1 comprises a functionalized robotic arm 10, 40, i.e., a robotic arm 40, which is functionalized thanks to an end effector 10 such as depicted in FIGS. 2 and 3. The end effector 10 is connected to the robotic arm 40. Alternatively, the robot and the functionalized arm may be supplied as a kit of parts, in which case the end effector 10 can be separately supplied (i.e., unassembled with the robotic arm yet). Still, the end effector 10 is designed to be connectable to the robotic arm 40 and can thus be connected thereto by a user. The end effector is further structured to connect to a charge port 220 of a vehicle. The robot 1 further includes a camera system 102 having depth sensing capability and a computerized system 2. The latter can be operatively connected to the functionalized robotic arm 10, 40 and configured to perform steps as described above in reference to the present methods.

As seen in FIGS. 2 and 3, the end effector 10 is preferably designed so as to integrate a connecting module 100, enabling connection with the robotic arm 40, and an actuator 114, 115, which protrudes transversely from a body 108 of the end effector, to ease operations such as depicted in FIGS. 4A-4C. Preferred designs of the end effector are discussed in detail in section 2.3.

FIG. 1 illustrates a possible configuration of the robot 1, in which an end effector 10 is axially connected to a terminal link of the robotic arm 40. The latter is controlled by a robot arm controller 70, which is itself in data communication with a master computer 2 (not shown in FIG. 1, see FIG. 7). The arm 40 is mounted on a workstation 80, which stores a further end effector 10b. The respective charging cables 12 are connected to a charging station 50, e.g., in a wallbox configuration. Preferably, the functionalized robotic arm 10, 40 further includes a light source 60, which is arranged to illuminate towards the second side of the reference plane P, i.e., to illuminate the car body, in operation. Section 2.4 provides additional details as to a possible system configuration.

A final aspect of the invention concerns a computer program product for automatically charging an electric vehicle via an end effector 10 of a robotic arm 40 of an automated vehicle charging robot 1 such as described above. The robot 1 is assumed to include processing means 2 and a camera system 102 having depth sensing capability. The computer program product comprises a computer-readable storage medium having computer-readable program code embodied therewith. The computer-readable program code can be evoked by the processing means 2 (e.g., a general-purpose computer) of the robot 1 to cause the latter to perform several operations, such as described earlier in reference to the present methods. In particular, the computer-readable program code may cause to estimate a reference position (or pose) of a reference feature 210 of the vehicle by obtaining both a 2D image and a depth image, extracting contour points from the 2D image, reconstructing 3D coordinates of the extracted contour points based on the depth information, matching a geometric object (e.g., a 2D plane) to the reconstructed 3D coordinates, and finally determining the reference position (or pose) of the reference feature based on the matched geometric object, as discussed earlier. Additional aspects related to computer-program products are discussed in detail in section 3.

The above embodiments have been succinctly described in reference to the accompanying drawings and may accommodate a number of variants. Several combinations of the above features may be contemplated. Examples are given in the next sections.

### 2. Specific Embodiments

### 2.1 Preferred High-Level Flow, FIG. 5

FIG. 5 shows a preferred high-level flow, which assumes the use of effectors 10, 10b, which can be controllably attached to and detached from the robotic arm, as assumed in FIGS. 1-3. At step S10, the robotic arm connects to an end effector 10, with a view to electrically charging a vehicle. To that aim, the system 1 first determines S20 whether the charge port door is closed, using standard computer vision. If so (S30, Yes), another algorithm is run to determine S40 the door pose. This algorithm relies on a contour point extraction, as described in section 1 (see also section 2.2). Next, step S50, the robotic arm 40 actuates the end effector 10 for the actuator 114, 115 to establish S50 contact and open S60 the charge port door. Else, i.e., if the charge port door is already open (S30, No), the algorithm directly goes to step S80, to determine S80 the charge port pose, e.g., using another or additional algorithm, e.g., based on VO. Once this is done, the robotic arm 40 actuates the end effector 10 for the plug 106 of the effector 10 to establish S90 contact and connect S100 to the charge port 220, with a view to charging the vehicle. Use is advantageously made of a force feedback provided by a force-torque sensor 103 (see below). Eventually, the robotic arm 40 disconnects S120 the end effector from the charge port, prior to closing S130 the corresponding charge port door, by adequately moving the actuator 114, 115. Once the charge port door is closed S140, the robotic arm may bring the end effector back to the workstation and disconnects from this end effector. Another sequence may then be started. Note, once it has plugged the connector 106, 108 onto a respective charge port, the robotic arm may possibly disconnect S110 from the end effector, with a view to starting another sequence, using another end effector 10b, e.g., to charge another vehicle or disconnect a charge vehicle. I.e., the robotic arm may fetch another end effector, in order to charge a further vehicle or disconnect this other end effector from another vehicle, should the latter be fully charged.

### 2.2 Preferred Flow of Contour Point Extraction, FIG. 6

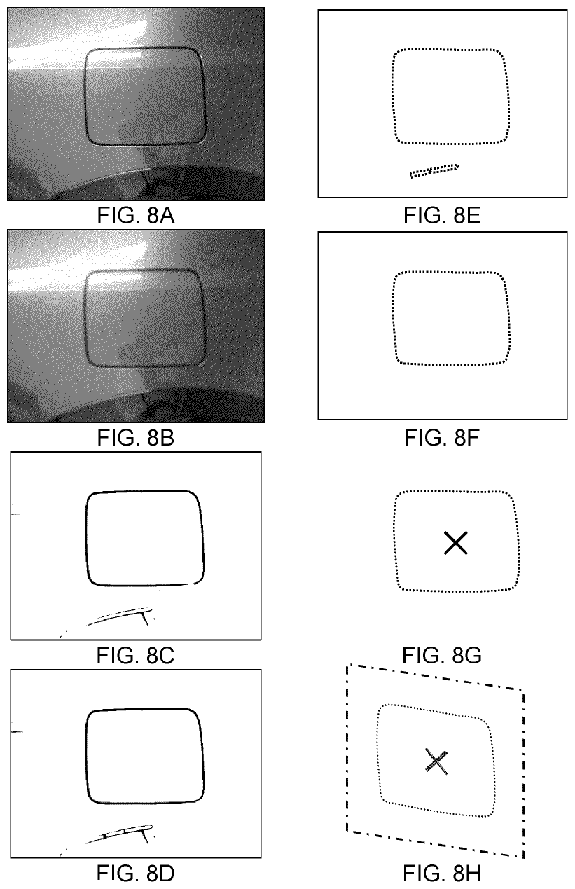

The following describes a preferred pipeline of algorithms used to sequentially process images of the charge port door 220, in reference to FIGS. 6 and 8A-8H. The aim is to extract S43 contour points of the charge port door 220, with a view to match a geometric model (a 2D plane) to it.

First, the camera 102 is instructed S41 to acquire S42 a 2D image. An example of such an image is shown in FIG. 8A. Note, this image may typically be an RGB picture, initially. Still, the RGB image is preferably converted to grayscale, to make sure the algorithm is invariant to colour.

The resulting image is then preferably filtered S431 using a low-pass filter, such that a filtered image is obtained, as shown in FIG. 8B. The low-pass filter retains low-frequency information within the image, while reducing high-frequency information. I.e., the filter averages out rapid changes in intensity, which results in blurring or smoothing the image. The image may for instance be filtered with a Gaussian kernel of size 9×9 and a variance of σ²=1.0. This preliminary step allows smoother contours to be subsequently extracted.

Next, the filtered image is segmented by applying a thresholding method, which results in a segmented image such as shown in FIG. 8C. Doing so after the filtering step S431 makes it possible to get rid of noise. The filtered image is preferably segmented S432 by running an adaptive binary threshold algorithm. The latter can for instance be chosen or designed so as to cause to compute a per-pixel threshold by convolving the 2D image with a Gaussian kernel. Compared to traditional image thresholding method, an adaptive thresholding method results in that the threshold value differs from pixel to pixel, which makes it possible to detect regions that are locally much darker than their surroundings. For instance, the per-pixel threshold can be computed by convolving the filtered, grayscale image with a Gaussian kernel of size 21×21. FIG. 8C shows the result of such an operation. As an alternative to image thresholding, a canny edge detector can be employed to detect the contrast difference. However, such an approach may fail in practice because reflections close to the contour may happen to be misclassified as edges.

If necessary, a morphological closing operation is applied S433 to the segmented image to obtain an augmented image, in which small “holes” have been removed, as depicted in FIG. 8D. I.e., missing contour parts are inferred and inserted in the deficient image, to avoid an inadvertent invalidation of the resulting contour. However, this step is optional, inasmuch as contour points may, in principle, be directly extracted from the segmented image.

Closed contours can then be identified S434 from the augmented image. For example, a suitable closed contour can be determined by identifying S434 all closed contours in the 2D image (as illustrated in FIG. 8E) and then determining S435 the most promising contour as that contour that has the largest area (FIG. 8F), as this would typically corresponds to the expected contour. If necessary, the closed contour accordingly identified may be validated by comparing S436 to a reference contour, e.g., using an image distance algorithm or by computing a distance between features extracted (e.g., using a machine-learning extractor set to extract semantic features) from the candidate contour and one or more reference contours. Such a validation step makes it possible to reject false positives. Alternatively, the selection step S435 can be skipped, in which case all determined closed contours may directly be compared to one or more reference contours, in order to identify a most suitable closed contours (e.g., using again the vectors corresponding to the extracted features).

In variants, machine learning techniques can be applied to directly segment the door contour. Interestingly, a cognitive model (such as based on a convolutional neural network) can be trained to suitably segment the door contour, whether closed or open, based on a suitable preliminary classification. An advantage of such an algorithm is that it can be used irrespective of the state (open vs. closed) of the charge port door, thereby eliminating the need for point set registration. Doing so requires a carefully calibrated cognitive model and makes it unnecessary to perform the adaptive thresholding S432, the morphological operation S433, and the selection S434, S435 of the largest contour, since such operations are implicitly captured by internal layers of the neural network.

Eventually, contour points are extracted S438 from a validated contour, and the 3D coordinates of the extracted points are determined S47 based on the depth information obtained at steps S44-S46. Next, the centroid of such 3D point coordinates is computed, as illustrated in FIG. 8G. Finally, a 2D plane is matched to the 3D coordinates of the extracted contour points, and the centroid is projected in the matched plane, see FIG. 8H. This may first require aligning S46 the 2D image and the depth image obtained, prior to extracting the contour points. This way, the depth values are rightfully mapped onto pixel values of the 2D image, such that the contour points extracted are rightfully associated to their corresponding depth values.

The depth information is preferably extracted thanks to a stereo depth camera 102, having two sensors 1022, 1024, spaced a small distance apart, which are used to independently acquire distinct images, as described in section 1. At step S44, the present methods instruct the camera 102 to obtain a depth image. In response to this instruction, the camera 102 illuminates S452 the target with an IR pattern (using the IR projector 1023), then obtains S454 two image datasets from the two distinct sensors, and finally computes S452 depth values by correlating pixel values from the two image datasets to generate a depth image, e.g., using processing means embedded in the camera. Given that the camera 102 would likely produce a combined image, in which depth values are attached to the pixel values, reading the depth values may require to access such values from the camera driver, separately from the pixel values.

Alternatively, the camera 102 may forward all the image data (including depth information) to an external computer 2 for it to correlate the pixel values and derive the depth information. Note, the 2D image obtained at step S42 may be an RGB image obtained via an RGB sensor 1021 short before or after deriving the depth values, or it may also be one of the two images read by the two sensors 1022, 1024. It may also be a combined image. In all cases, the image used at step S43 needs to be consistent with the depth values. Step S46 can be skipped if the image used is one of the images produced by the IR sensors 1022, 1024 at step S454, since the depth values are already correlated with the corresponding image values at step S456. In practice, the 2D image used at step S43 can either be an image obtained by the RGB sensor 1021 or by one of the IR sensors 1022, 1024.

### 2.3 Preferred End Effector Designs

The end effector 10 shown in FIGS. 1-3 basically comprises a connecting module 100, an electrical connector 106, 108, and an actuator 114, 115.

The connecting module 100 is generally designed to enable a connection of the end effector 10 to the robotic arm 40. In practice, the end effector can be connected to a terminal link of the robotic arm 40, as illustrated in FIG. 1. As shown in FIGS. 2 and 3, the connecting module 100 is delimited by a reference plane P. The reference plane P corresponds to the back plane of the module 100. This plane P delimits two opposite sides. The end effector 10 is meant to connect to the robotic arm 40 on one side (hereafter the “first side”) and to the charge port 220 of the vehicle on the opposite side (the “second side”). The connection to the robotic arm is made on the first side of the reference plane P, which corresponds to the back side of the end effector 10. This connection is essentially a mechanical connection, even if it may involve electromagnetic connection means 104, 105, as in embodiments discussed later. If necessary, the end effector 10 may further be electrically connected to the robotic arm 40. Preferably, however, the electrical connector is directly connected to a charging cable 12, itself connected to a charging station 50, as illustrated in FIG. 1. The charging cable 12 may thus be fully independent from the robotic arm 40.

The electrical connector 106, 108 of the end effector includes a body 108 and a plug 106. The plug 106 is designed to connect (i.e., plug) into a charge port 220 of a vehicle, see FIGS. 1 and 4A-4C. That is, the plug 106 and the port 220 form mating parts, like a plug and a socket. The plug 106 is arranged at an end of the body 108. This end corresponds to the free end of the connector in practice, i.e., the residual free end of the end effector when the latter is mounted to the robotic arm 40. The body 108 extends from the connecting module 100 to the plug 106 on the second side of the reference plane P, along an extension direction Dₑ that is transverse to the reference plane P, see FIG. 2.

The actuator 114, 115 is a piece, part, or member, that protrudes from the body 108 of the electrical connector 106, 108, transversely to the extension direction Dₑ. That is, the actuator 114, 115 protrudes transversely from the average direction of the connector body 108. It preferably extends orthogonally to the average direction of the body 108 and, thus, orthogonally to the extension direction Dₑ. This actuator 114, 115 is generally designed to actuate a door 210 of the charge port 220 of the vehicle, as illustrated in FIG. 4A. It may for instance include a pressure member 115 on top of a protruding part 114, as shown in the accompanying drawings. That is, the protruding part 114 extends from the body 108 to the pressure member 115. The latter is designed to come into safe contact with the charge port door 210. The pressure member 115 is preferably coated by a soft material, such as foam, to avoid scratching or otherwise damaging the charge port door.

The connecting module 100 forms a mechanical interface, which enables a connection of the end effector 10 to the robotic arm 40 on the first side of the delimiting plane P. The mechanical interface may possibly be designed to allow a direct or an indirect mechanical connection, e.g., via intermediate submodules 104, 105. The connecting module 100 may for instance allow an axial connection to the terminal link of the robotic arm 40 (see FIG. 4A), perpendicularly to the reference plane P.

The body 108 of the electrical connector typically is a casing, which houses a terminal portion of a charging cable 12. This casing generally extends along the extension direction De. The connector body 108 has a form factor; it typically has an elongated form, the average direction of which is parallel to the extension direction Dₑ. The body 108 may have several sections of different sizes, where one of the sections includes the plug 106, while another section supports the actuator 114, 115, as assumed in the accompanying drawings. The actuator may for instance be mechanically fixed to the body 108 using conventional fasteners such as bolted joints, clamping a base of the member 114 onto a respective section of the body 108. For example, each bolted joint may include a male threaded part inserted in a matching female threaded part. In variants, other types of fasteners can be used, such as blind bolts or screws.

The average direction Dₐ of the actuator 114, 115 is preferably perpendicular to the extension direction Dₑ of the body 108. That is, the actuator 114, 115 may generally extend perpendicularly to the average direction of the connector body 108. In variants, some tolerance can be accepted (e.g., ±10° or, less preferably, up to ±20°), such that the angle formed between the actuator direction Dₐ and the average direction of the connector body Dₑ may typically be between 70° and 110°.

The connector body 108 extends transversely to the reference plane P, on the second side thereof. However, it is not necessarily orthogonal to the reference plane P (“transversely” does not necessarily mean “perpendicular”, i.e., at right angle to the reference plane). In fact, the average direction of the body 108 is much preferably inclined with respect to the connection axis D_{c}, so as to form an angle with respect to the plane P, for reasons explained below.

As defined above, the actuator is a rigid (i.e., static) element, which is solely actuated by the robotic arm, without requiring any active component (such as electric drives, pneumatic or hydraulic elements, magnetic actuators) to open the charge port door. That is, the end effector combines an electrical connector and a passive actuator, which is judiciously arranged with respect to the body of the electrical connector. Thanks to the proposed design, the end effector can be rotated by the robotic arm 40, so that the actuator 114, 115 can be set in position to safely actuate a charge port door 210, by pressing the door 210 at a certain location, as depicted in FIG. 4A. Accordingly, there is no need to provide separate tools (another end effector or robot) to open the vehicle charge port door 210. This, the above design makes it possible to reduce the time duration of the plugging process. This further reduces the overall costs, given that a single tool is needed to both open the charge port door and plug the connector. Such an end effector can be used in charging robot systems for various types of electric vehicles, such as plug-in electric cars (also called electrically chargeable vehicles), electric motorcycles and scooters, city cars, neighbourhood electric vehicles (microcars), vans, buses, electric trucks, and military vehicles.

As noted above, the extension direction Dₑ of the body 108 is preferably inclined with respect to an axial direction D_{c} that is perpendicular to the reference plane P. The axial direction D_{c} is the direction along which the end effector 10 is preferably mounted to the terminal link of the robotic arm 40. I.e., the connecting module 100 is preferably designed to allow the end effector 10 to axially connect to the robotic arm 40, along said axial direction D_{c}. In practice, the inclination of the extension direction Dₑ ensures, together with the actuator 114, 115 that protrudes from the body 108, a collision safety margin M (see FIG. 4A), which makes it possible to keep all elements on the backside 101 of the tool (e.g., connection elements 104, 105, force-torque sensor 103, and robotic arm 40) away from the car body 205, 210. This allows the end effector (and thus the actuator 114, 115) to be suitably rotated to open the charge port door 210 without causing collisions, as illustrated in FIG. 4A.

Note, the risk of collisions can further be lowered by recessing the actuator away from the plug 106, as discussed below. In addition, the proposed inclination makes it possible to avoid collisions between the robot arm and the car body during the plugging process, at least in certain cases. Still, the main reason for inclining the body 108 is that this avoids collisions between the robot and the car body during the door opening. I.e., inclining the direction De with respect to the direction D_{c} makes it possible to create a larger safety margin between the car body and the robot.

Thus, the extension direction Dₑ of the body 108 forms an angle a with the axial direction D_{c}, as seen in FIG. 2. This angle is typically between 25 and 45 degrees, preferably between 30 and 40 degrees, and more preferably between 34 degrees and 36 degrees. Accordingly, the connector body 108 is tilted with respect to the reference plane P, by an angle β that is between 45 degrees and 65 degrees, preferably between 50 degrees and 60 degrees, and more preferably between 54 and 56 degrees. The angle β is ideally equal to 55 degrees, as assumed in the accompanying drawings.

As evoked above, the actuator 114, 115 is preferably recessed with respect to the plug 106 along the extension direction Dₑ, so as to be closer to the connecting module 100 than to the plug 106. This allows the end plug 106 of the electrical connector 106, 108 to reach into the charge port 220 of the vehicle, while avoiding a collision with the actuator 114, 115. Moreover, this makes it possible to lower the risk of collision between the actuator 114, 115 and the vehicle charge port door 210, upon actuating (i.e., moving and rotating) the end effector 10.

In simple implementations, the connecting module 100 may restrict to a single component, e.g., a rear panel 101 that is integral with the body 108, as assumed in FIGS. 4A-4C. In that case, the rear panel of the end effector 10a is structured so as to allow a direct connection with the robotic arm 40. However, and as illustrated in FIGS. 2 and 3, the connecting module 100 preferably includes several submodules 101-105, which are designed to cooperate with each other to enable and ease the connection to the robotic arm 40.

In the examples of FIGS. 2 and 3, the submodules 101-105 are designed to enable a controllably attachable and detachable connection to/from the robotic arm 40. That is, the end effector 10 can be controllably attached to and detached from the robotic arm 40, such that a same robotic arm can successively pick up and plug several end effectors into respective charge ports. The submodules may, in general, involve mechanical, electromagnetic, and/or pneumatic means.

A preferred approach, however, is to rely on an electropermanent magnet. In that case, the submodules include two magnetic parts 104, 105, which form the electropermanent magnet. The two magnetic parts 104, 105 can notably be formed as two complementarily shapes (e.g., flanges), one of high-coercivity magnetic material and one of low-coercivity material. The external magnetic field is switched on or off by a pulse of electric current in a wire winding around one of the magnets. I.e., applying power makes it possible to demagnetize the parts and detach the flanges, in a controllable fashion. In addition, complementary mating features can be provided on each of the two magnetic parts to ensure a precise mechanical connection of the two magnetic parts. In variants, any suitable clutch mechanism can be used, e.g., involving mechanical devices and/or pneumatic equipment. However, an electropermanent magnet allows a simpler and yet accurate connection, making it easier to switch end effectors.

Several end effectors 10, 10b may be made available to a same robotic arm 40, as assumed in FIG. 1. Since each of the end effectors 10 is controllably attachable to and detachable from the robotic arm 40, the same robotic arm 40 can be used to connect several end effectors 10, 10b (and thus several charging cables) to several vehicles. In variants, or in addition, the plugs 106 of the available end effectors 10, 10b may conform to different plug standards (e.g., type 1-J1772, GB/T, Type 2, CCS-Type 2, etc.), such that the robotic arm may pick the appropriate end effector in accordance with the car type.

Note, the base of the robotic arm 40 may possibly be static (as assumed in FIG. 1), given that a same robotic arm may be rotated to reach 2 to 4 vehicles parked around it. In variants, the robotic arm 40 may possibly be translated (or otherwise moved) so as to adequately reach several vehicle charge ports. To that aim, various transportation means can be used. The robotic arm may for instance be mounted on an autonomous vehicle or be guided along a running surface, e.g., a magnetic track, or be suspended from one or more cables, for example, so as to successively reach several parked vehicles.

Other end effector designs can be contemplated. The accompanying drawings show two types of end effectors 10. The end effector 10 shown in FIGS. 1-3 involve intermediate magnetic parts 104, 105 (which form an electropermanent magnet), at variance with the end effector 10a seen in FIGS. 4A-4C.

In both cases, the end effector 10, 10a can be axially fixed to the robotic arm 40 via a force-torque sensor 103. I.e., the force-torque sensor 103 is designed to be fixedly mounted, axially, to the robotic arm 40, whereby the end effector 10 axially connects to the robotic arm 40 via the force-torque sensor 103. That is, the connecting module 100 can be regarded as including at least two parts 101, 103, which are the rear panel 101 and the force-torque sensor 103, where the latter is meant to be axially fixed (i.e., fixedly mounted, axially) to the terminal link of the robotic arm 40. In other words, the force-torque sensor 103 is axially connectable, on the one hand, to the robotic arm and, on the other hand, to another one of the submodules 101, 104, 105. In the example of FIGS. 4A-4C, the force-torque sensor is directly fixed, axially, to the rear panel of the end effector 10a. Once fixed to the rear panel, the force-torque sensor can be considered to form part of the connecting module. In variants, the end effector is designed so as for the force-torque sensor to be integral therewith.

In the examples of FIGS. 2, 3, the force-torque sensor 103 is axially fixed to the magnetic part 105, in addition to be axially fixed to the terminal link of the arm 40. The magnetic part 105 is meant to magnetically attach to the part 104, itself fixed to the rear panel 101 of the end effector 10. That is, the part 104 is fixedly mounted to the end section (i.e., the rear panel) 101 of the body 108 of the electrical connector, whereas the other part 105 is fixedly mounted, axially, to the force-torque sensor 103. This allows the end effector 10 to be controllably attached to and detached from the robotic arm 40.

Forces applied from the backside of the force-torque sensor 103 will not have an impact on the force-torque measurements. Conversely, forces applied from the frontside notably via the elements 106, 108, (104, 105), and 101, will influence the force-torque measurements. In variants, the body 108 of the electrical connector 106, 108 can be directly connected to the robotic arm 40. However, providing a force-torque sensor 103 is advantageous, inasmuch as it allows alignment constraints to be somewhat relaxed. That is, for cable plugging, a compliance control that exploits force feedback can be used to compensate for estimation uncertainties and limit contact reaction forces, which are due to the rather high stiffness of the materials involved. Accordingly, the system can actively react to alignment errors upon cable plugging, such that constraints in terms of accuracy needed to align the electrical connector can be relaxed. In particular, exploiting feedback signals from the force-torque sensor 103 circumvents the need for sub-millimetre accuracy in the placement of the connector.

The algorithm used to align the connector 106, 108 with the charge port (i.e., once the charge port door is open) may rely on computer vision or a two-step method as described in section 1. To that aim, use can be made of the camera 102, which may advantageously be fixed to the force-torque sensor 103, as illustrated in FIGS. 1-3. Given that the force-torque sensor 103 is the last of the submodules, i.e., the farthest from the plug 106, the camera 102 is maximally recessed from the end plug 106. This results in maximizing the field of view (or field of vision) of the camera 102. In addition, because the camera is mounted to the base of the force-torque sensor, forces and torques caused by inadvertent tension of the camera cable (e.g., a USB cable connected to the camera) do not measurably impact the force-torque sensor measurements. Consequently, less disturbance forces and torques are acting on the end effector. This improves the quality of the force-torque measurements and simplifies the force feedback-controlled mating process.

The camera 102 is preferably arranged asymmetrically with respect to connector body 108. That is, the camera is preferably located on one side (either side) of the plane spanned by the directions Dₐ and Dₑ, such that neither the camera 102 nor its cable comes to collide with the safety margin resulting from the inclination of the body 108 and the protruding actuator 114, 115. That is, the camera is preferably placed on the left or right side of the end effector, so as not to interfere with the safety margin. This is particularly true where the end effector 10a is free of intermediate connection elements 104, 105, as in FIGS. 4A-4C. For an end effector 10 as shown in FIG. 2 or 3, which includes intermediate connecting elements 104, 105, the camera 102 may also be placed on top, without jeopardizing the safety margin. Placing the camera on top may actually simplify the motion execution, given that less motion is required to acquire images in that case.

The asymmetric placement of the camera also help achieve a configuration, in which neither the actuator 114, 115 nor the body 108 of the electrical connector 106, 108 is in the field of view of the camera 102. Various additional design options can be contemplated to make sure to free the field of view of the camera. For example, the camera 102 can be offset, i.e., attached to the sensor 103 via an arm that is long enough for the camera 102 to be sufficiently offset from the connector 106, 108. Such a solution can, however, lead to undesired inertial effects and interfere with the rotational movements of the end effector. Thus, a simpler solution is to tilt the camera 102 with respect to a vertical axis.

In more detail, the depth camera 102 includes at least two sensors, themselves including lenses, the optical axes of which are parallel and transverse to the reference plane P. Now, these optical axes can be slightly rotated around the rotation axis Dₜ, which is parallel to the projection Dₚ of the extension direction Dₑ in the reference plane P. This is best seen in FIG. 2, where the camera 102 is tilted by an offset angle γ. This offset angle can be chosen so that neither the actuator 114, 115 nor the body 108 of the electrical connector 106, 108 is in the field of view of the camera 102. Yet, it should remain as small as possible, so as for the camera to correctly capture the scene of interest. The optimal offset angle depends on the dimensions of the various components involved. In practice, this angle will typically be between 10 degrees and 30 degrees. It preferably is between 17 degrees and 23 degrees when adopting an end effector design as shown in FIGS. 1-4C, although the camera may also be placed on top, should intermediate connecting parts be used, as in FIGS. 2 and 3. For an end effector design as shown in FIGS. 4A-4C, it is optimal to tilt the camera by 20 degrees.

The camera is preferably arranged vertically, as shown in FIG. 2, such that its sensors 1021-1024 are arranged along an axis that is parallel to the rotation axis Dₜ. Still, the optical axes of the two sensors are slightly rotated around the rotation axis Dₜ, as a result of the fact that the camera 102 is tilted by an offset angle γ.

### 2.4 Examples of Practical Realizations

Robotic arms. Various types of robotic arms can be contemplated, as long as such arms are capable of handling payloads on the order of 1.5 to 3.0 kilograms, i.e., corresponding to the typical mass of the present end effectors (taking into account the mass of the cable that is effectively supported by the arm, in operation). The rear element of the connecting module 100 can be adapted to match any type of terminal link of the robotic arm. In general, suitable robotic arms will include several links, connected by joints allowing rotational motions and possibly translational (linear) displacement, where the links form a kinematic chain. The robotic arms are normally programmable and supplied with adequate computing means. Use can for instance be made of an industrial manipulator from Universal Robots, such as the UR10e robot.

Cameras. Various types of cameras can be contemplated too. Use if preferably made of a stereo depth camera relying on IR projection, such as Intel Realsense D435 or D435i. Such cameras have a form factor; they can be vertically arranged and tilted, as discussed above, whereby its sensors (i.e., RGB sensor 1021, IR sensors 1022 and 1024, and the IR beamer 1023) are vertically aligned.

Force-torque sensors. Various types of force-torque sensors can be used. Preferred is to rely on a 6-axis force-torque sensor, such as the Bota Systems SensONE 6-axis force-torque sensor, to measure reaction forces acting on the tools.

End effectors. The end effector designs proposed herein integrate several tools, notably the male part (i.e., the plug 106) of the charging cable and the actuator 114, 115. Both tools are rigidly linked to the wrench of the force-torque sensor 103, such that it is possible to measure reaction forces acting on the tool centre points. As noted earlier, the depth camera 102 can be directly mounted to the housing of the force-torque sensor, as an eye-in-hand camera, because this allows to compensate for absolute position errors of the manipulator, which can typically be on the order of millimetres. All the required parts of the body 108 can be 3D printed using fused deposition modelling and polylactic acid filaments. It is desired to firmly attach the charging cable 12 to the force-torque sensor 103, as any slippage or deformations could lead to errors in the tool calibration, which would decrease the success rate of the plugging algorithm. The inlet of the charging cable is preferably constrained, mechanically, to ensure a certain angle between the cable 12 and the lower part of the body 108, and accordingly prevent inadvertent interferences between the cable 12 and the robotic arm 40.

Electropermanent magnets. Various types of electropermanent magnet parts can be used too, such as the Magnetic Tool Changer NTC-E10 flanges from Unchained Robotics.

System. FIG. 7 shows a schematic overview of a preferred system architecture. One option is to rely on a single (master) computer 2, e.g., a standard desktop computer 2 using Ubuntu 20.04 as operating system and a standard kernel (e.g., LINUX 5.4). The robot arm controller 70 and the force-torque sensor 103 are connected to the master computer 2 using Ethernet (via the network switch 3). Other communications (e.g., to/from the camera 102 and to the LED control unit 65) can be ensured via a universal service bus (USB) hub 4, as depicted in FIG. 7. Alternatively, two computers may be used, one running Ubuntu 20.04 and an RT-kernel (e.g., LINUX 5.4 Preemt-RT kernel patch) to run the real-time critical force controllers and trajectory-following controllers, the other running Ubuntu 20.04 and a standard kernel (e.g., LINUX 5.4) to run other algorithms (e.g., vision algorithms, state machine algorithms, etc.). All required software can for instance be written in C++ 14 and python 3. An adequate robot operating system (e.g., noetic) is used as middleware for communication between the individual software modules and devices.

### 3. Technical Implementation Details

More generally, computerized devices can be suitably designed for implementing embodiments as described herein. In that respect, it can be appreciated that the methods described herein are largely non-interactive, if not entirely automated. Such methods can be implemented based on software (possibly firmware), hardware, or a combination thereof. The computer program code is executed by suitable digital processing devices, e.g., using general-purpose digital computers, such as personal computers, workstations, etc., or special-purpose processing means.

The computer program product may include a computer readable storage medium (or media) having computer readable program instructions thereon for causing a processor to carry out aspects of the present invention. This medium can be a tangible device that can retain and store instructions for use by an instruction execution device. The storage medium may for example be an electronic, optical, or electromagnetic storage device, typically a semiconductor device.

Computer readable program instructions as described herein can be downloaded to respective computing/processing devices. However, the computer readable storage medium is not to be construed as transitory signals per se. For example, the computer readable program instructions may execute entirely on the master computer 2, or partly on a peripheral computer (e.g., integrated in the camera 102 or accompanying the robotic arm 40) and the master computer 2. In variants to embodiments discussed in section 2.4, electronic circuitry including, for example, programmable logic circuitry, field-programmable gate arrays (FPGA), or programmable logic arrays (PLA) may execute the computer readable program instructions, in order to perform steps of the present invention.

Aspects of the present invention are described herein with reference to flowchart illustrations and/or block diagrams of methods, and apparatuses (systems), according to embodiments of the invention. It will be understood that at least some of these blocks, and combinations of such blocks can be implemented by computer readable program instructions. These computer readable program instructions may be provided to processing means to produce a machine, such that the instructions create means for implementing the functions/acts specified in the flowcharts. These computer readable program instructions may also be stored in a computer readable storage medium that can direct a computer, a programmable data processing apparatus, and/or other devices, to function in a particular manner. The computer readable program instructions may also be loaded onto processing means to cause a series of operational steps producing in a computer-implemented process, as specified in the flowchart blocks.

The flowcharts illustrate the architecture, functionality, and operation of possible implementations of systems, methods, and computer program products, according to embodiments of the present invention. In this regard, each block in the flowcharts may represent a module, segment, or portion of instructions, which comprises one or more executable instructions for implementing the specified logical function(s). In some alternative implementations, the functions noted in the blocks may occur out of the order assumed in the accompanying drawings. For example, two blocks shown in succession may, in fact, be accomplished as one step, executed concurrently, substantially concurrently, in a partially or wholly temporally overlapping manner, or the blocks may sometimes be executed in the reverse order, depending upon the functionality sought.

While the present invention has been described with reference to a limited number of embodiments, variants, and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant, or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention is not limited to the particular embodiments disclosed, but that the present invention will include all embodiments falling within the scope of the appended claims. In addition, many other variants than explicitly touched above can be contemplated. For example, other types of robotic manipulators, cameras, electropermanent magnets, and force-torque sensors, may be contemplated. In addition, the end effectors shown in FIGS. 1-4C may be designed so as to show different visual qualities.

### REFERENCE LIST

1 Automated vehicle charging robot
10, 10a, End effectors
10b
10, 40 Functionalized robotic arm
100 Connecting module
101 Rear panel/end section of electrical connector body
101-105 Connecting submodules
101, 106, Electrical connector
108
102 Depth camera (1021: RGB sensor; 1022: first IR sensor; 1023: IR beamer; 1024: second IR sensor)
103 Force-torque sensor
104, 105 Electropermanent magnet parts
106 Electrical connector plug
108 Electrical connector body
114 Actuator protruding part
114, 115 Charge port door actuator
115 Actuator pressure member
12 Charging cable
2 Computerized system/master computer
205 Vehicle body
210 Vehicle charge port door
220 Vehicle charge port
3 Network switch
40 Robotic arm
50 Charging station
60 Light source
70 Robotic arm controller
80 Workstation
Dₐ Average actuator direction
D_{c} Axial direction
Dₑ Extension direction of electrical connector
Dₚ Extension direction projection in reference plane P
Dₜ Camera rotation axis
P Reference plane
α Angle between extension direction Dₑ of body 108 and axial direction D_{c}
β Angle between connector body 108 and reference plane P
γ Camera offset angle

1. A computer-implemented method for automatically charging an electric vehicle via an end effector of a robotic arm of an automated vehicle charging robot, wherein the end effector is structured to connect to a charge port of a vehicle and the automated vehicle charging robot further includes a camera system having depth sensing capability, and wherein the method comprises:
estimating a reference position of a reference feature of the vehicle thanks to the camera system;
based on the estimated reference position, determining a pose of a charge port of the vehicle; and
based on the determined pose of the charge port, instructing the robotic arm to actuate the end effector to connect it to the charge port with a view to charging the vehicle,
wherein the reference position is estimated by:
obtaining both a 2D image and a depth image of a surface portion of the vehicle, the surface portion including the reference feature;
extracting contour points of the reference feature from the 2D image obtained;
based on the depth image obtained, reconstructing 3D coordinates of the extracted contour points;
matching a geometric object to the reconstructed 3D coordinates; and
determining the reference position of the reference feature based on the matched geometric object.

2. The method according to claim 1, wherein
the geometric object is matched to the reconstructed 3D coordinates by fitting the geometric object to the reconstructed 3D coordinates.

3. The method according to claim 2, wherein
the geometric object is a 2D plane, and
the 2D plane is matched to the reconstructed 3D coordinates using a random sample consensus algorithm.

4. (canceled)

5. The method according to claim 1, wherein the reference position is determined by
computing a centroid of the reconstructed 3D coordinates and
projecting the computed centroid onto the geometric object as matched to the reconstructed 3D coordinates.

6. The method according to claim 1, wherein the method further comprises:
estimating, thanks to the camera system, the pose of a reference coordinate system of the reference feature based on the matched geometric object, whereby
the reference position of the reference feature is estimated as part of estimating the pose of the reference coordinate system and
the pose of the charge port is determined based on the pose of the estimated reference coordinate system.

7. The method according to claim 6, wherein
the reference feature is a door of the charge port, and
the method further comprises instructing the robotic arm to actuate the end effector to open the door, based on the estimated pose of the reference coordinate system, prior to determining the pose of the charge port.

8. The method according to claim 1, wherein the pose of the charge port is determined by
obtaining a rough estimate of the pose and then
refining this rough estimate based on a geometric transformation determined by comparing a query image obtained thanks to the camera system with a representation of the charge port corresponding to a reference configuration, for which a pose of the end effector with respect to the charge port is known.

9. The method according to claim 1, wherein extracting the contour points of the reference feature comprises
determining a closed contour in the 2D image and then extracting the contour points from this closed contour,
wherein said closed contour is determined by:
identifying all closed contours in the 2D image; and
determining said closed contour as one of the closed contours that has a largest area.

10. (canceled)

11. (canceled)

12. The method according to claim 9, wherein
extracting the contour points of the reference feature further comprises segmenting the 2D image by applying a thresholding method to obtain a segmented image; and
determining said closed contour further comprises applying a morphological closing operation to the segmented image to obtain an augmented image, whereby the closed contours are identified from the augmented image.

13. The method according to claim 12, wherein the 2D image is segmented by
the method further comprises aligning the 2D image and the depth image obtained, prior to extracting the contour points,
extracting the contour points further comprises filtering the 2D image using a low-pass filter to obtain a filtered image, prior to segmenting the filtered image, and
the 2D image is segmented by running an adaptive binary threshold algorithm, causing to compute a per-pixel threshold by convolving the 2D image with a Gaussian kernel.

14. (canceled)

15. (canceled)

16. The method according to claim 1, wherein the depth image is obtained by instructing the camera system to:
obtain two image datasets from two sensors of the camera system that are spaced apart from each other; and
forward the two datasets to a processor, for it to compute depth values by correlating pixel values in the two image datasets to generate a depth frame.

17. The method according to claim 1, wherein the depth image is obtained by
instructing the camera system to illuminate the surface portion with a pattern of infrared IR light, so as to impact the pixel values of the two image datasets obtained.

18. An automated vehicle charging robot, comprising
a functionalized robotic arm including a robotic arm and an end effector, wherein the end effector is connected or connectable to the robotic arm and is structured to connect to a charge port of a vehicle,
a camera system having depth sensing capability, and
a computerized system, which is operatively connected to the functionalized robotic arm and configured to:
estimate a reference position of reference feature of the vehicle thanks to the camera system;
determine a pose of a charge port of the vehicle based on the estimated reference position; and
instruct, based on the determined pose of the charge port, the robotic arm to actuate the end effector to connect it to the charge port with a view to charging the vehicle,
wherein, in operation, the reference position is estimated by:
obtaining both a 2D image and a depth image of a surface portion of the vehicle, the surface portion including the reference feature;
extracting contour points of the reference feature from the 2D image obtained;
based on the depth image obtained, reconstructing 3D coordinates of the extracted contour points;
matching a geometric object to the reconstructed 3D coordinates; and
determining the reference position of the reference feature based on the matched geometric object.

19. The automated vehicle charging robot according to claim 18, wherein the end effector includes:
a connecting module, which is delimited by a reference plane and is designed to enable a connection of the end effector to the robotic arm on a first side of the reference plane;
an electrical connector including a body and a plug, the plug designed to connect to the charge port and arranged at an end of the body, wherein the body extends from the connecting module to the plug on a second side of the reference plane, the second side opposite to said first side, along an extension direction that is transverse to the reference plane; and
an actuator that protrudes from said body, transversely to said extension direction, the actuator designed to actuate a door of the vehicle charge port.

20. The automated vehicle charging robot according to claim 19, wherein
the extension direction of the body is inclined with respect to an axial direction that is perpendicular to the reference plane, whereby the extension direction of the body forms an angle with the axial direction wherein this angle is between 25 degrees and 45 degrees.

21. The automated vehicle charging robot according to claim 19, wherein
the connecting module includes several submodules designed to cooperate with each other to enable said connection, as a controllably detachable connection, and
the camera system includes a camera that is fixed to one of the submodules that is the farthest from the plug.

22. The automated vehicle charging robot according to claim 21, wherein
the submodules include a force-torque sensor, which is axially connected or connectable to another one of the submodules, and
the camera is fixed to the force-torque sensor.

23. The automated vehicle charging robot according to claim 21, wherein
the camera is arranged on one side of a plane containing the extension direction and a projection of the latter in the reference plane, in such a manner that neither the actuator nor the body of the electrical connector is in a field of view of the camera.

24. The automated vehicle charging robot according to claim 23, wherein
the camera is a stereo vision camera that includes two sensors having respective lenses, the optical axes of which are parallel to each other and transverse to the reference plane,
the optical axes are rotated around a rotation axis that is parallel to the projection of the extension direction, by an offset angle chosen so that neither the actuator nor the body of the electrical connector is in the field of view of the camera, wherein the offset angle between 10 degrees and 30 degrees, and
the two sensors are arranged along an axis that is parallel to the rotation axis.

25. A computer program product for automatically charging an electric vehicle via an end effector of a robotic arm of an automated vehicle charging robot, the end effector structured to connect to a charge port of a vehicle, wherein the robot further includes processing means and a camera system having depth sensing capability wherein the computer program product comprises a computer-readable storage medium having computer-readable program code embodied therewith and the computer-readable program code can be evoked by said processing means to cause the latter to estimate a reference position of a reference feature of the vehicle by:
obtaining both a 2D image and a depth image of a surface portion of the vehicle, the surface portion including the reference feature;
extracting contour points of the reference feature from the 2D image obtained;
based on the depth image obtained, reconstructing 3D coordinates of the extracted contour points;
matching a geometric object to the reconstructed 3D coordinates; and
determining the reference position of the reference feature based on the matched geometric object.
